(19) United States
(12) Patent Application Publication
(10) Pub. No.: US 2011/0141180 A1
(43) Pub. Date: Jun. 16, 2011

(54) IMAGE FORMING APPARATUS AND METHOD OF INKJET HAVING HUMIDITY ADJUSTMENT MECHANISM

(75) Inventors: Masahiro Doi, Shizuoka-ken (JP); Satoshi Kaiho, Kanagawa-ken (JP); Kazuhiko Ohtsu, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/958,596

(22) Filed: Dec. 2, 2010

Related U.S. Application Data
(60) Provisional application No. 61/285,393, filed on Dec. 10, 2009.
(60) Provisional application No. 61/285,402, filed on Dec. 10, 2009.

(51) Int. Cl. B41J 29/38; B41J 2/01

(52) U.S. Cl. 347/16; 347/101

(57) ABSTRACT

According to one embodiment, an ink-jet image forming apparatus includes an ink-jet head ejecting an aqueous ink to form an image on a surface of a recording medium, a carrying belt carrying the recording medium and at least a part of which is situated upstream from the ink-jet head in a direction of carrying the recording medium, and a solution adhering unit adhering a solution to a water-retentive surface of the carrying belt.

### CROSS-REFERENCE TO RELATED APPLICATIONS

This application is based upon and claims the benefit of U.S. Provisional Applications No. 61/285,393, filed on Dec. 10, 2009; and No. 61/285,402, filed on Dec. 10, 2009; the entire contents of which are incorporated herein by reference.

### FIELD

Embodiments described herein relate generally to an ink-jet image forming apparatus having a mechanism to humidify a medium, and an image forming method.

### BACKGROUND

Generally, a medium used in an ink-jet image forming apparatus is ink-jet coated paper having a coated layer with high ink absorptiveness, matte paper or the like. However, since ink-jet coated paper or the like is costly and has poor writability, normal paper (general-purpose paper) for PPC is increasingly used recently as the medium.

When printing is performed on normal paper for PPC with an aqueous ink-jet ink, the paper fiber swells with moisture of the ink and paper cockling or curling tends to occur. When the cockled or curled paper is carried within a printing apparatus, the paper is likely to collide with components such as the head and thus cause a paper jam.

### BRIEF DESCRIPTION OF THE DRAWINGS

FIG. 1 shows an exemplary schematic configuration of an ink-jet image forming apparatus according to an embodiment.

FIG. 2 is an exemplary block diagram showing the configuration of a control system of an ink-jet image forming apparatus according to an embodiment.

FIG. 3 shows an exemplary schematic configuration of an ink-jet image forming apparatus according to an embodiment.

FIG. 4 shows an exemplary relation between the quantity of applied solution and cockling according to an embodiment.

FIG. 5 shows an exemplary relation between the quantity of applied solution and curling according to an embodiment.

FIG. 6 shows an exemplary schematic configuration of an ink-jet image forming apparatus according to an embodiment.

FIG. 7 shows an exemplary schematic configuration of an ink-jet image forming apparatus according to an embodiment.

FIG. 8 shows an exemplary schematic configuration of an ink-jet image forming apparatus according to an embodiment.

FIG. 9 is an exemplary flowchart showing schematic procedures for acquiring image information in an ink-jet image forming apparatus according to an embodiment.

### DETAILED DESCRIPTION

In general, according to one embodiment, an ink-jet image forming apparatus includes an ink-jet head ejecting an aqueous ink to form an image on a surface of a recording medium, a carrying belt carrying the recording medium and at least a part of which is situated upstream from the ink-jet head in a direction of carrying the recording medium, and a solution adhering unit adhering a solution to a water-retentive surface of the carrying belt.

### First Embodiment

In a first embodiment, an ink-jet image forming apparatus having ink-jet heads for four colors will be described.

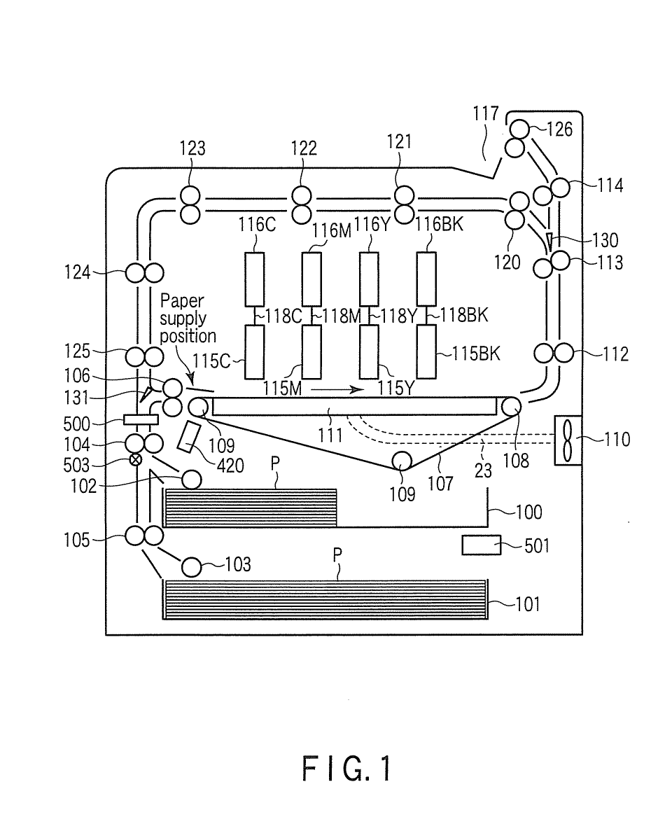

FIG. 1 shows an exemplary schematic configuration of an ink-jet image forming apparatus according to an embodiment.

Sheet cassettes 100 and 101 hold sheets p of different sizes. A paper supply roller 102 or 103 takes out a sheet p corresponding to the selected sheet size from the sheet cassette 100 or 101, and carries the sheet p to a carrying roller pair 104 or 105 and a registration roller pair 106. The sheet p is not ink-jet paper but normal paper.

A carrying belt 107 is given a tension by a driving roller 108 and two driven rollers 109. Here, the driven roller 109 situated near the position (paper supply position) where the sheet on the upstream side in the sheet carrying direction first contacts the carrying belt 107 is defined as an upstream roller. On the face side of the carrying belt 107, many small-diameter through-holes are provided at predetermined intervals. The carrying belt 107 is an endless belt produced by stacking a rubber on a fiber and then polishing the face side. Small-diameter holes, not shown, are opened on the entire surface. The carrying belt 107 may also be formed by processing the ends of a belt with ends made of stainless steel or the like.

The back side of the carrying belt 107, which is the side contacting the driven roller 108, is installed in such a manner that the top plate of a negative-pressure chamber 111 tightly contacts the back side of the carrying belt 107. The negative-pressure chamber 111 is connected to a fan 110 through a duct 23. The negative-pressure chamber 111 is a box-like casing which has the top plate on which many grooves and holes are provided, and a hole for connecting the air discharge duct 23. The inside of the hollow casing is set to a negative pressure through the suction by the fan 110.

With the suction force generated by the suction fan 110, the sheet p is sucked to the carrying side of the carrying belt 107 via the duct 23, the negative-pressure chamber 111 and the many small-diameter holes on the carrying belt 107. The sheet p is then carried while still being sucked to the carrying belt 107.

On the paper discharge side (right side in FIG. 1), carrying roller pairs 112, 113, 114 and a paper discharge roller pair 126 are installed. The sheet p is discharged to a paper discharge tray 117 by the paper discharge roller pair 126.

A carrying guide 130 and carrying roller pairs 120, 121, 122, 123, 124 and 125 for sending the sheet p back again to the paper supply side (left side in FIG. 1) at the time of carrying out double-side printing, and a carrying guide 131 which switches the path of the sheet p for back-side printing are installed. The carrying guides 130 and 131 are configured to change the direction of the distal end of the guide about a fulcrum. The carrying guide 130 switches the carrying route of the sheet p between the paper discharge side and the paper supply side. The carrying guide 131 switches between the path to reverse the face and back sides of the sheet p and the carrying path to carry the sheet p for back-side printing.

Above the carrying belt 107, four line-type ink-jet heads 115 which eject ink to a sheet according to image data are provided in parallel. In order from upstream (left side in FIG. 1), an ink-jet head 115C which ejects a cyan (C) ink, an ink-jet head 115M which ejects a magenta (M) ink, an ink-jet head 115Y which ejects a yellow (Y) ink, and an ink-jet head 115Bk which ejects a black (Bk) ink are arranged. Moreover, a cyan (C) ink cartridge 116C, a magenta (M) ink cartridge 116M, a yellow (Y) ink cartridge 116Y, and a black (Bk) ink cartridge 116Bk which hold the ink of the corresponding colors are provided for the ink-jet heads 115. Each ink-jet head 115 and ink cartridge 116 are connected with each other by a tube 118.

A humidifier 420 is arranged facing the driven roller 109. The humidifier 420 humidifies the face side of the carrying belt 107 to restrain the cockling or curling shape. The configuration of the humidifier 420 will be described later.

As state detection sensors used for humidification control, a temperature and humidity detection sensor 501, a sheet thickness detection sensor 500 and a sheet width detection sensor 503 are provided. The temperature and humidity detection sensor 501 detects the temperature and humidity of the environment where the machine is used. The sheet thickness detection sensor 500 detects the thickness of the sheet p. The sheet width detection sensor 503 detects the width of the sheet. The width of the sheet refers to the size of the sheet in the direction orthogonal to the direction in which the sheet is carried.

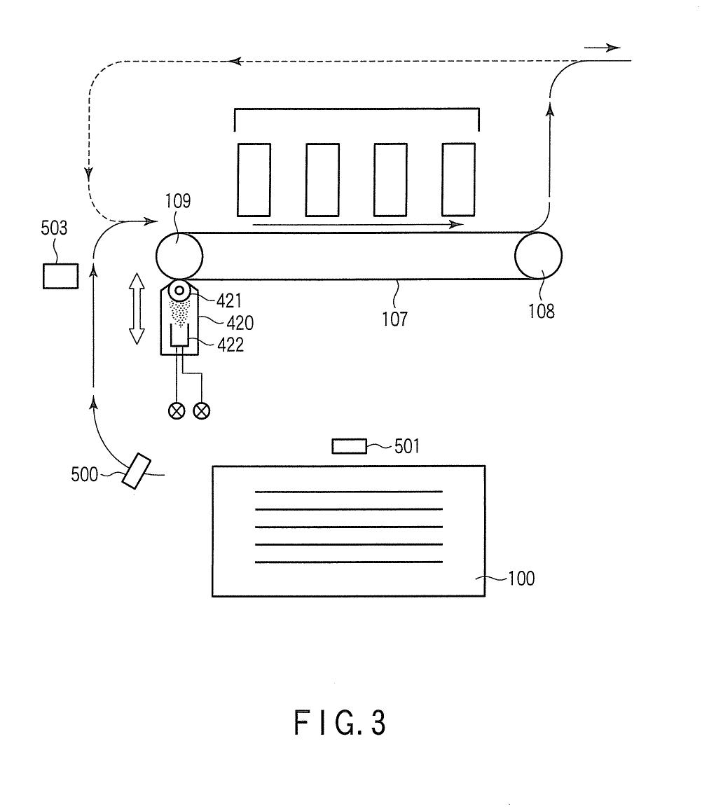

The humidifier 420 has a humidifying roller 421 and a sprayer 422, the details of which are shown in FIG. 3, and a casing which collectively holds the humidifying roller and the sprayer in an integrated form.

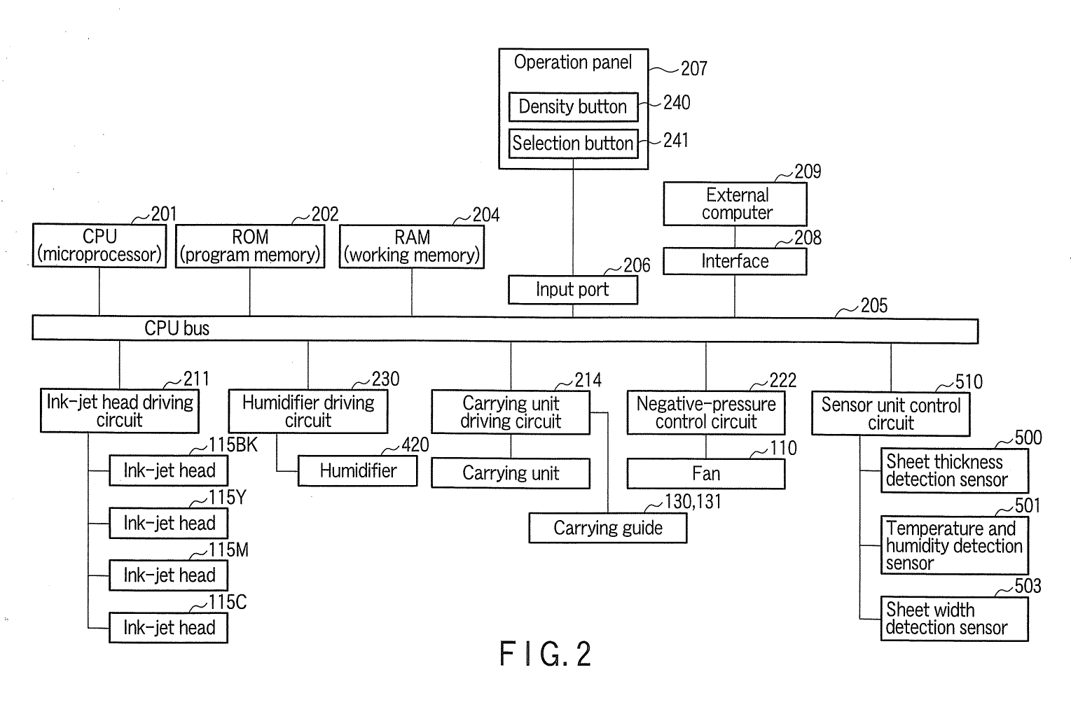

FIG. 2 is an exemplary block diagram showing the configuration of a control system of an ink-jet image forming apparatus according to an embodiment.

The control system of the ink-jet image forming apparatus has a CPU (central processing unit) 201 as a processor, a ROM (read only memory) 202, a RAM (random-access memory) 204, a CPU bus 205, an input port 206, an interface 208, an ink-jet head driving circuit 211, a carrying unit driving circuit 214, a negative-pressure control circuit 222, and a humidifier driving circuit 230. The processor also serves as a controller.

The CPU 201 centrally controls each units of the ink-jet image forming apparatus. The ROM 202 and the RAM 204 are connected to the CPU 201 via the CPU bus 205 and thus form a microcomputer. The ROM 202 stores an operation program to execute driving control. The input port 206 transmits and receives information to and from an operation panel 207. The interface 208 transmits and receives information to and from an external computer 209. The operation panel 207 includes a density button 240 for selecting the density at the time of forming an image, and a selection button 241 for selecting double-side printing or single-side printing.

The ink-jet head driving circuit 211 drives each ink-jet head 115 to operate. The carrying unit driving circuit 214 drives each carrying unit and the carrying guides 130 and 131. The negative-pressure control circuit 222 controls the operating voltage of the fan 110. The humidifier driving circuit 230 controls the operation of the humidifier 420. A sensor unit control circuit 510 controls the sheet thickness detection sensor 500, the temperature and humidity detection sensor 501 and the sheet width detection sensor 503.

Next, the operation of the control system will be described. Each unit of the ink-jet image forming apparatus is basically controlled by the CPU 201. Each unit is controlled according to the operation program stored in the ROM 202. Under such driving control, the ink-jet heads 115, the carrying unit, the carrying guides 130 and 131, and the fan 110 operate as follows.

First, image data or a print command that is sent from the external computer 209 via the interface 208 is transferred to the RAM 204 and is processed by the CPU 201 on the basis of the operation program stored in the ROM 202, stored command data and the like. The processed print data is sent to the ink-jet head driving circuit 211 and a driving signal for printing is sent to each ink-jet head 115.

The ink-jet head driving circuit 211 operates according to the image data or the like, and the ejection of ink from the ink-jet heads 115 is controlled in timing when the sheet p is carried by the carrying unit driving circuit 214. A recording density is selected on the basis of an instruction from the density button 240. Information whether to apply a double-side recording mode or a single-side recording mode is received on the basis of an instruction from the selection button 241. This information is sent to the ink-jet head driving circuit 211. The ejection from the ink-jet heads 115 is thus controlled.

The carrying unit driving circuit 214 controls the carrying unit and moves the sheet p synchronously with the operation of each ink-jet head 115. The carrying unit driving circuit 214 also executes control of the carrying guides 130 and 131 in order to change the carrying path in accordance with the single-side printing mode or the double-side printing mode.

At the time of image formation, a driving signal to each unit that is processed by the CPU 201 is sent to the ink-jet head driving circuit 211, the carrying unit driving circuit 214 and the negative-pressure control circuit 222. Each unit in the ink-jet image forming apparatus is drive-controlled according to the operation program and thus records an image on the sheet p. Similarly, in the case of double-side printing, the ink-jet heads 115, the carrying unit and the fan 110 are controlled in predetermined operation timing according to the operation program.

The operation panel 207 is provided in order to set details of the environment where the ink-jet image forming apparatus operates and to display the operation state of the operation process or the like.

FIG. 3 shows an exemplary schematic configuration of an ink-jet image forming apparatus according to an embodiment. In FIG. 3, the configuration is simplified in order to make the explanation easier.

As shown in FIG. 3, in the ink-jet image forming apparatus, the sheet supply cassette 100, an ink-jet head loading unit, a sheet carrying unit, and the humidifier (solution application unit) 420 are arranged. The humidifier 420 includes the humidifying roller 421, the sprayer 422, and the casing which holds the humidifying roller and the sprayer in an integrated form.

The humidifier 420 applies a solution to the carrying belt 107. As the solution applied to the carrying belt 107 is transferred to the back side of the sheet p, the cockling and curling shape of the sheet p is restrained.

The sprayer 422 sprays the solution in a quantity that is determined according to image forming conditions, uniformly in the direction of the width of the humidifying roller 421. The humidifying roller 421 contacts the carrying belt 107 and humidifies a predetermined range on the carrying belt 107.

The solution that is applied can be a liquid with its viscosity or the like adjusted, water, or a treatment solution which improves image quality and water resistance. For example, the treatment solution contains water at approximately 30 to 80% by weight and additives such as a wetting agent to improve wettability and a surface active agent.

A highly water-retentive film is pasted to the face side of the carrying belt 107. This film is made of a material that does not repel or drain the applied treatment solution or the like, but holds the treatment solution. For example, a material (cushion glass paper, direct offset plate or the like) used for an image forming unit or the like of a printer or the like may be used.

Next, the operation of the ink-jet image forming apparatus will be described.

If a printing instruction is given from the control unit of the CPU 201, the sheet p is picked up from the sheet supply cassette 100. The sheet p that is picked up is carried below the ink-jet heads by the sheet carrying unit (belt). Many small holes are opened in the carrying belt 107. As air is sucked through the holes, the sheet p is sucked to the carrying belt 107 and is thus carried.

The face side of the belt is humidified by the humidifier 420 before the sheet p contact the carrying belt 107. If the sheet P contacts the humidified carrying belt 107, the humidifying solution is applied to the sheet p from the carrying belt 107.

The humidifier 420 applies the solution to the carrying belt 107 according to image forming conditions. For example, on the basis of information from the sheet thickness detection sensor 500 arranged on a sheet passage, the humidifier 420 applies the solution in a quantity corresponding to the thickness of the sheet p, to the carrying belt 107. The humidifier 420 also changes the quantity of the applied solution, on the basis of information acquired from the temperature and humidity detection sensor 501 incorporated in the machine. Whether humidification is required or not is controlled in accordance with the width of the sheet p.

At the time of double-side printing, the quantity of the applied solution the first time is made smaller than the quantity of the applied solution in single-side printing, and the quantity of the applied solution the second time is similarly reduced. The water content of the applied solution is made greater for an image with a high print rate. The water content of the applied solution is made smaller for an image with a low print rate.

As the medium which is humidified in contact with the carrying belt 107 is carried through the sheet carrying unit and passes below the ink-jet head loading unit, printing is performed on the medium. After that, the medium is discharged out of the image forming apparatus.

Next, the effect of reduction in cockling and the amount of curling in the case where the solution is applied will be described.

The relation between the quantity of the applied solution, and cockling and the amount of curling, is examined using a testing device. The testing device used for the examination has a medium carrying mechanism which carries a medium (sheet) and an ink-jet head mechanism which forms an image.

Each of (i) a medium to which no solution is applied, (ii) a medium to which 0.1 g of the solution is applied and (iii) a medium to which 0.2 g of the solution is applied is supplied and an image is formed thereon. Immediately after printing, cockling is measured with a laser interferometer and the amount of curling is measured with a scale. The biggest peak value and several following peak values in the measured waveform are picked up and the average value of these peak values is defined as the measured value. The weight of the solution is for one A4 sheet having a basis weight of 80 g.

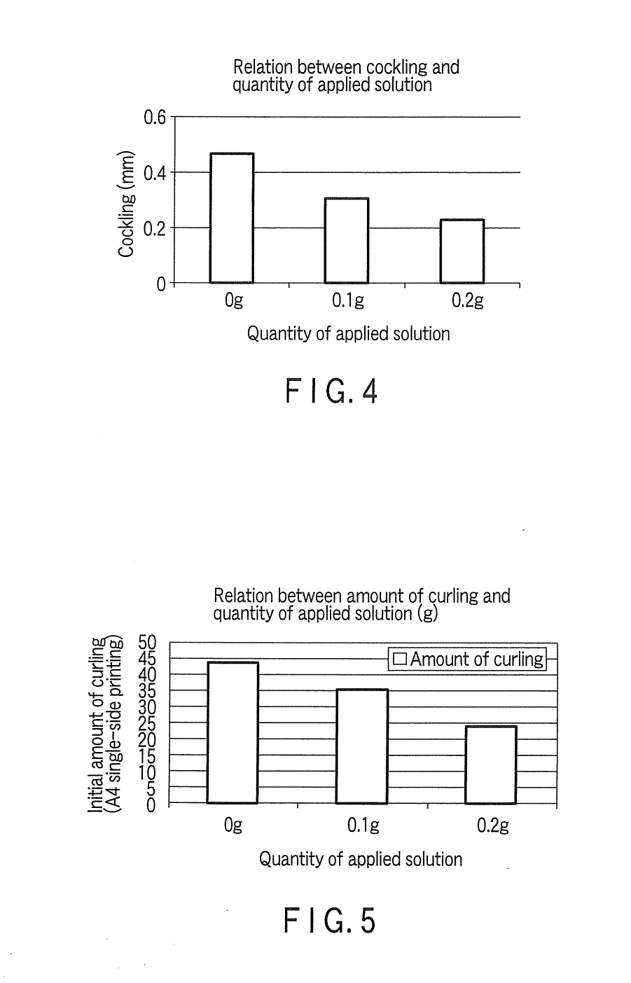

FIG. 4 shows an exemplary relation between the quantity of the applied solution and cockling according to an embodiment. FIG. 5 shows an exemplary relation between the quantity of the applied solution and the amount of curling according to an embodiment.

As shown in FIG. 4 and FIG. 5, both cockling and the amount of curling are reduced as the quantity of the applied solution is increased ((i)>(ii)>(iii)).

From these results, it can be understood that the application of the solution has the effect of reducing cockling and the amount of curling.

It is also found out that paper curling and cockling increases in proportion to the density of a printed image and increases if the humidity of the sheet is lower. It is also found out that curling increases as the image is closer to the edges of the sheet, and also increases as the width of the sheet becomes broader. Therefore, by changing the range of humidification and the quantity of humidification (water content) according to the density of the printed image, the printing position, the width of the sheet and the environment of use (humidity), it is possible to reduce the amount of curling and the amount of cockling more stably.

In this embodiment, the belt is humidified in advance so that a range of 0 to 100 mm from the forward edge of the sheet is uniformly humidified with the water content of about 0.05 to 0.4 g where the following conditions are met.

(1) The humidity is 60% or lower in the environment of use of the machine.

Curling and cockling tend to occur easily if the humidity is low.

(2) The sheet size in the direction (direction of the width) orthogonal to the direction in which the sheet travels is 220 mm or greater.

Curling and cockling tend to occur easily if the width of the sheet is broad.

(3) A case where solid printing with a high density occupies 50% or more of the area of a part within 40 mm from the forward edge of the sheet (the print rate of 50% or higher).

Curling and cockling tend to occur easily if high-density printing is done in the forward end part of the sheet.

(4) A case where double-side printing is carried out.

Curling and cockling tend to affect printing easily in double-side printing.

(5) The basis weight of the paper is 110 g/m² or smaller.

Curling and cockling tend to occur easily if the paper is thin.

Humidification is carried out if one of the conditions (1) to (5) is met. However, humidification is not carried out if none of these conditions is met.

The water content applied to the carrying belt 107 is adjusted so that the quantity of the solution applied to one A4 sheet is 0.05 to 0.4 g.

The range of humidification on the medium and the quantity of the applied solution, which are humidification conditions, are not always the same and can be changed depending on each of the following conditions, that is, (1) the humidity condition, (2) the width of the sheet, (3) the range of the printed image and its density, (4) double-side printing or single-side printing, and (5) the thickness of the paper (type of the sheet). Further, the humidification conditions can be changed depending on a combination of some of the above conditions (1) to (5).

The range of humidification on the medium can be adjusted by moving the humidifier 420 shown in FIG. 3 into contact with or away from the carrying belt 107. The mechanism for this movement of the humidifier may utilize a cam or solenoid, though not shown.

In the case of double-side printing, the side of the medium to be humidified can be selected from the following A to C in accordance with the above conditions (1) to (5).

Mode A: a second side before printing a first side (i.e., back side)+a first side before printing a second side (i.e., back side)

Mode B: only a second side before printing a first side (i.e., back side)

Mode C: only a first side before printing a second side (i.e., back side)

In the Mode A, before each side is printed in double-side printing, for example, a range of 0 to 100 mm from the forward edge on the back side of the sheet is humidified. In the Mode B, only before the first side is printed in double-side printing, for example, a range of 0 to 100 mm from the forward edge on the back side of the sheet is humidified. In the Mode C, only before the last side is printed in double-side printing, for example, a range of 0 to 100 mm from the forward edge on the back side of the sheet is humidified.

Next, variations of the first embodiment will be described.

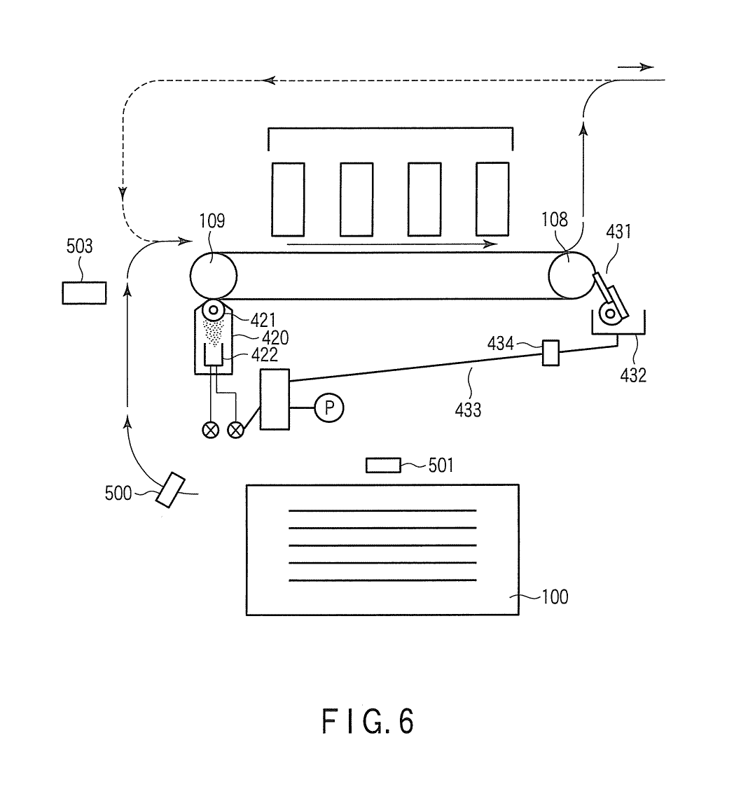

FIG. 6 shows an exemplary schematic configuration of an ink-jet image forming apparatus according to an embodiment. The ink-jet image forming apparatus shown in FIG. 6 has a mechanism which collects and reuses the humidifying solution that is left on the carrying belt 107.

A blade 431 which collects the humidifying solution that is left on the carrying belt 107 is supported to contact the face side of the carrying belt 107 in the sheet carrying roller unit after the sheet is separated. The humidifying solution collected from the belt is gathered into a humidifying solution collection tank 432 by the blade 431. For the collected humidifying solution, a humidifying solution recirculating path (pipe) 433 is connected to the humidifying solution collection tank 432. In the humidifying solution recirculating path, a filter 434 to remove impurities from the collected solution is arranged. Also, in the humidifying solution recirculating path, a pump 435 to return the collected humidifying solution to the humidifier 420 is arranged. With the above configuration, it is possible to collect and reuse the excess humidifying solution. Thus, the humidifying solution can be effectively used and the quantity of the solution used can be reduced.

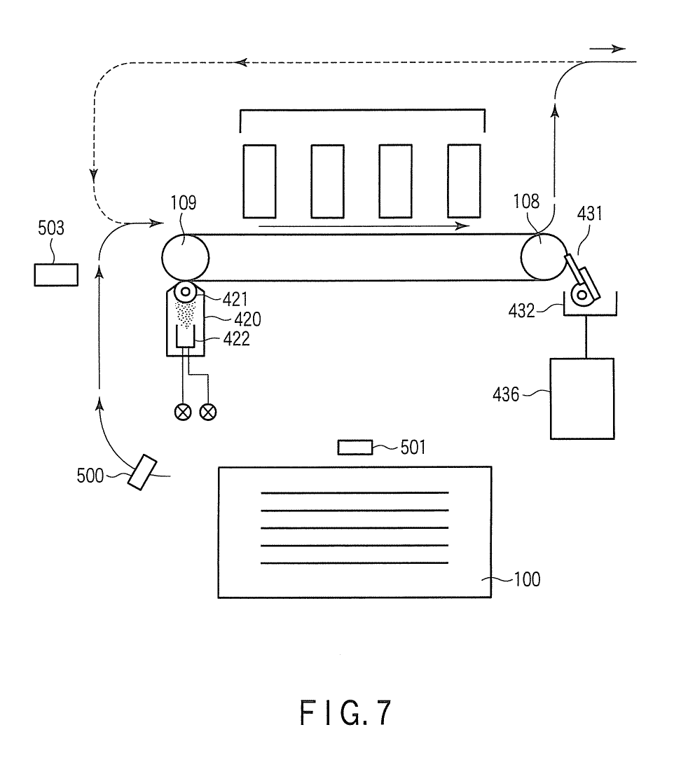

FIG. 7 shows an exemplary schematic configuration of an ink-jet image forming apparatus according to an embodiment. In the ink-jet image forming apparatus shown in FIG. 7, the blade 431 which collects the humidifying solution that is left on the carrying belt 107 is supported to contact the face side of the carrying belt 107 in the sheet carrying roller unit after the sheet is separated. The humidifying solution collected from the belt is gathered into the humidifying solution collection tank 432 by the blade 431. A waste solution tank 436 to dispose of the humidifying solution gathered in the humidifying solution collection tank 432 is arranged. The humidifying solution collection tank 432 is connected with the waste solution tank 436. Although the excess humidifying solution is collected from the carrying belt 107, the collected humidifying solution is not reused and is processed as a waste solution. Therefore, the filter shown in FIG. 6 is not provided and the collected humidifying solution is sent out to the waste solution tank from the humidifying solution collection tank.

As the humidifying solution is applied to the medium according to the above-described embodiment, the deformation (cockling and curling) of paper that occurs if printing is carried out on the medium with an aqueous ink can be reduced.

### Second Embodiment

A second embodiment is different from the first embodiment in the structure of the humidifier. The same parts as in the first embodiment are denoted by the same reference numerals and will not be described further in detail.

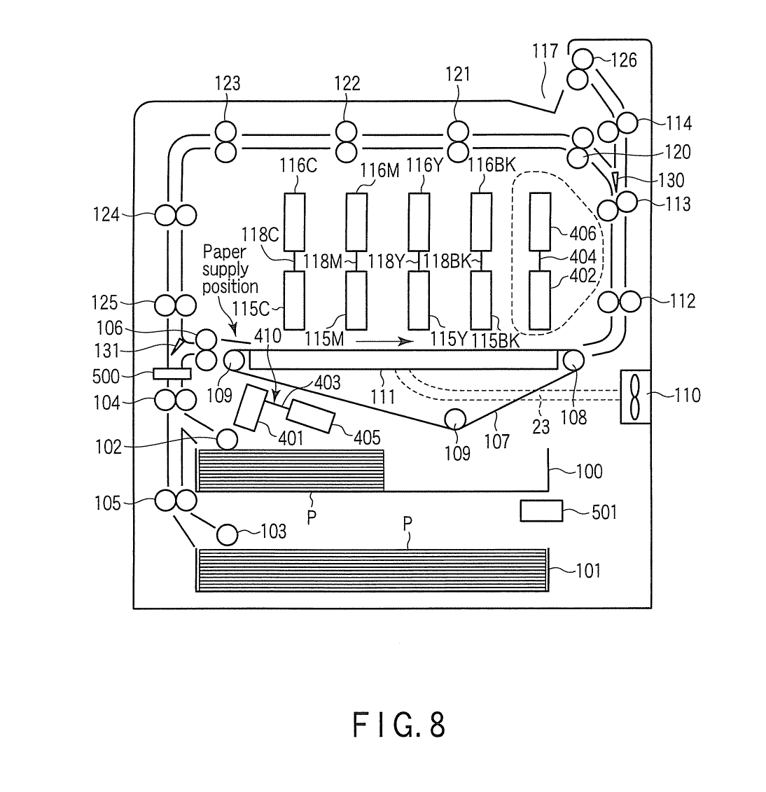

FIG. 8 shows an exemplary schematic configuration of an ink-jet image forming apparatus according to an embodiment.

In the second embodiment, a humidifier 410 is arranged in the periphery of the carrying belt 107, for example, a position immediately preceding the paper supply position in the direction of carrying the recording medium. The humidifier 410 has a solution supply head 401, a solution supply tube 403 and a solution cartridge 405. The solution supply head 401 is connected with the solution cartridge 405 via the solution supply tube 403.

The solution supply head 401 has a configuration similar to that of the ink-jet heads 115. The solution supply head 401 ejects a solution stored in the solution cartridge 405 toward the carrying belt 107. As the solution, a treatment solution which improves image quality and water resistance can be used. For example, the treatment solution contains water at approximately 30 to 80% by weight and additives such as a wetting agent to improve wettability and a surface active agent.

A highly water-retentive film is pasted to the face side of the carrying belt 107, as described above. This film is made of a material that does not repel or drain the applied treatment solution or the like, but holds the treatment solution. Therefore, the solution can be held in an arbitrary area on the carrying belt 107, instead of uniformly humidifying the range of 0 to 100 mm from the forward edge of the carrying belt 107 as in the first embodiment.

Here, the solution supply head 401 has the configuration similar to that of the ink-jet heads 115 but may have a lower nozzle resolution than that of the ink-jet heads 115. The spacing between the solution supply head 401 and the carrying belt 107 is broader than the spacing between the ink-jet heads 115 and the carrying belt 107. For example, the spacing between the solution supply head 401 and the carrying belt 107 may be four times broader than the spacing between the ink-jet heads 115 and the carrying belt 107.

The position where the humidifier is arranged may be a terminal end position in the direction of carrying the recording medium (a position near the ink-jet heads 115). A solution supply head 402, a solution supply tube 404 and a solution cartridge 406 surrounded by a dotted line in FIG. 8 represent a humidifier that is arranged at a new position. If the humidifier is arranged at this position, liquid droplets are ejected in the direction of gravity and therefore an area of the solution can be accurately formed on the carrying belt 107.

Next, the operation of the ink-jet image forming apparatus will be described.

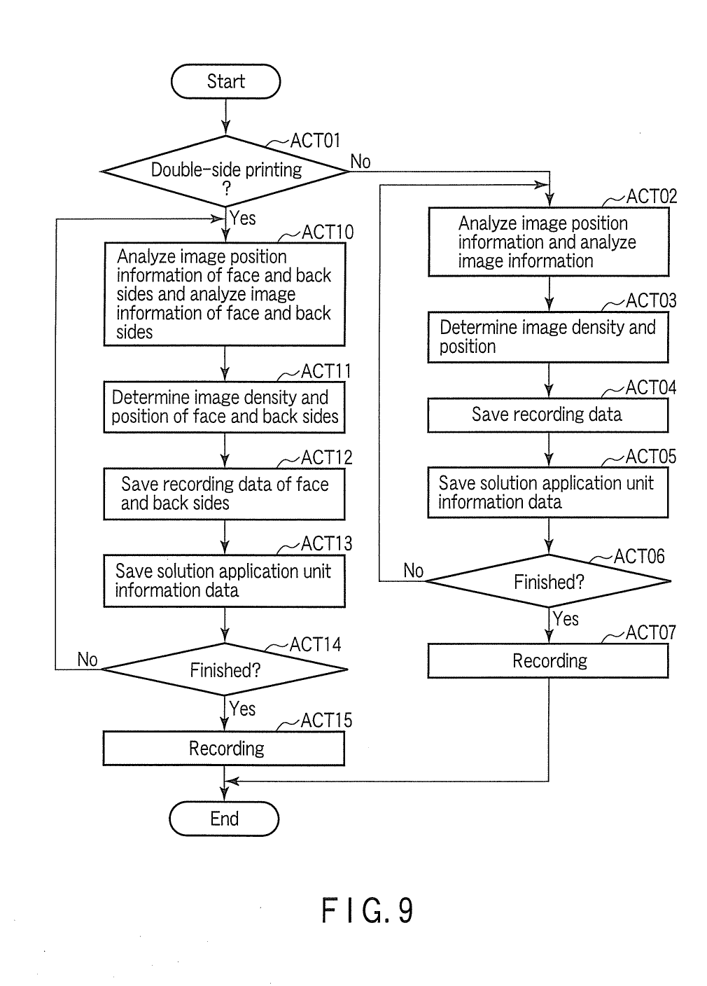

FIG. 9 is an exemplary flowchart showing schematic procedures for acquiring image information in an ink-jet image forming apparatus according to an embodiment. The operation will be described with reference to the flowchart of FIG. 9, the configuration of the control system shown in FIG. 2 and the configuration of the ink-jet image forming apparatus shown in FIG. 8. If a printing instruction is inputted from the operation panel 207 via the input port 206, the CPU 201 determines whether double-side printing (double-side recording) is designated or not (ACT 01).

If the CPU 201 determines that single-side recording is requested (No in ACT 01), the CPU 201 analyzes image position information and image information received from an external computer (ACT 02). The CPU 201 acquires image position information and image density information (ACT 03). The CPU 201 temporarily stores the image position information and image density information in the RAM 204 as recording data (ACT 04). The CPU 201 calculates position information and solution application information for an area where no image is formed on the basis of the image position information and image density information and temporarily stores the calculated information as solution application unit information data in a place different from the recording data in the RAM 204 (ACT 05).

The CPU 201 determines whether the calculation and storing is carried out for all the recording information or not (ACT 06). If the CPU 201 determines that the calculation and storing is not carried out for all the recording information (No in ACT 06), the CPU 201 returns to ACT 02. If the CPU 201 determines that the calculation and storing is carried out for all the recording information (Yes in ACT 06), the CPU 201 controls the recording operation of the ink-jet forming apparatus on the basis of the temporarily stored image data and solution application unit information data (ACT 07). In single-side recording, the solution is applied to the back side in the area where no image is printed. Thus, humidification with an aqueous ink and humidification with the solution are carried out over the entire surface of the sheet.

If the requested recording information indicates double-side recording (Yes in ACT 01), the CPU 201 analyzes image position information of the face and back sides and image information of the face and back sides received from an external computer (ACT 10). The CPU 201 acquires position information of images on the face and back sides and image density information of the face and back sides (ACT 11). The CPU 201 temporarily stores the position information of the images on the face and back sides and the image density information of the face and back side in the RAM 204 as recording data (ACT12). The CPU 201 calculates position information and solution application information for an area where no image is formed on the basis of the position information of the images on the face and back sides and the image density information of the face and back sides and temporarily stores the calculated information as solution application unit information data in a place different from the recording data in the RAM 204 (ACT 13).

The CPU 201 determines whether the calculation and storing is carried out for all the recording information or not (ACT 14). If the CPU 201 determines that the calculation and storing is not carried out for all the recording information (No in ACT 14), the CPU 201 returns to ACT 02. If the CPU 201 determines that the calculation and storing is carried out for all the recording information (Yes in ACT 14), the CPU 201 controls the recording operation of the ink-jet forming apparatus on the basis of the temporarily stored image data and solution application unit information data (ACT 15). In single-side recording, the solution is applied to the back side in the area where no image is printed. Thus, humidification with an aqueous ink and humidification with the solution are carried out over the entire surface of the sheet.

The recording operation of the ink-jet image forming apparatus will be described in detail. In the following description, a side on which an image is formed first, of the two sides of the medium, is defined as the face side.

The CPU 201 transfers image data for recording on the face side of the recording medium, to the ink-jet heads 115C, 115M, 115Y and 115Bk. The CPU 201 also transfers the solution application unit information data for solution application, to the solution supply head 401 or the solution supply head 402. Although both the solution supply head 401 and the solution supply head 402 are described in FIG. 8, it suffices to arrange one of the solution supply heads in this example and it is not necessary to arrange both of the solution supply heads.

As the CPU 201 outputs a print start signal, first, the carrying unit driving circuit 214 drives the driving roller 108 to drive the carrying belt 107. Synchronously with this driving signal, the solution supply head 401 or the solution supply head 402 selectively applies (adheres) the solution in a predetermined quantity to a predetermined place on the face side of the carrying belt 107 in accordance with the solution application unit information data. The face side of the carrying belt 107 is subjected to water retention treatment. The timing of carrying the sheet and the timing of driving the belt are adjusted so that the appropriate quantity of the solution that is selectively held on the face side of the carrying belt 107 is transferred to an appropriate part on the back side of the sheet p that is picked up. The timing is adjusted on the basis of a sheet p passage signal to the sheet thickness detection sensor 500.

The sheet p is picked up one by one from the sheet cassette 100 or 101 by the paper supply roller 102 or 103 and is carried to the carrying roller pairs 104 and 105 and the registration roller pair 106.

The carrying guide 131 is turned in a predetermined direction so that the sheet p is carried through a predetermined carrying path. The registration roller pair 106 corrects the skew of the sheet p and carries the sheet p in predetermined timing. The humidification of the back side of the sheet p may be less precise than the image formation to a certain extent because of the influence of the blurring of the solution or the like. Therefore, the influence of slight misalignment due to the small-diameter holes on the carrying belt 107 and the skew poses no problem.

In the humidification, information from the sheet thickness detection sensor 500 arranged on the sheet passage is also incorporated in the control. In order to transfer the solution applied in a predetermined quantity corresponding to the thickness to the sheet p, the quantity of the solution ejected from the solution supply head 401 or the solution supply head 402 is controlled. Moreover, information acquired from the temperature and humidity sensor 501 is also incorporated in the control. In order to transfer the solution applied in a predetermined quantity corresponding to humidity to the sheet p, the quantity of the solution ejected from the solution supply head 401 or the solution supply head 402 is controlled. As the number of droplets ejected from the solution supply head 401 or the solution supply head 402 is made variable, the quantity of the solution transferred to the back side of the sheet p is adjusted.

Since the negative-pressure chamber 111 sucks air in with the fan 110 via the many small-diameter holes on the carrying belt 107 and the duct 23, the sheet p in the state of being sucked to the carrying belt 107 is carried below the ink-jet heads 115. As the sheet p is sucked to the carrying belt 107, predetermined spacing can be maintained between the ink-jet heads 115 and the sheet p.

Synchronously with the timing when the sheet p is carried, the inks of the individual colors are ejected from the ink-jet heads 115C, 115M, 115Y and 115Bk.

Thus, a color image is formed at a desired position on the face side of the sheet p. Since the timing of applying the solution to the face side of the carrying belt 107 is adjusted to meet the position of image formation on the sheet p, the solution is transferred to a desired position on the back side of the sheet p.

In the case of the single-side printing mode, the sheet p with an image formed on its face side is discharged by the carrying roller pairs 112, 113, 114 and 126. In the case of carrying out single-side recording only, after an image is formed on the face side of the sheet p in the first recording (face-side recording), the sheet p is carried by the carrying roller pairs 112, 113 and 114 and is discharged face down (with the recorded side facing down) to the paper discharge tray 117 by the paper discharge roller pair 126. In this case, the carrying guide 130 is turned in a predetermined direction so that the sheet p is carried through a predetermined carrying path. When the sheet is discharged face down in the single-side recording, the face side is the first page.

In the case of the double-side printing mode, the sheet p is temporarily returned to the paper supply position near the sheet cassettes 100 and 101 by the carrying roller pairs 112, 113, 120, 121, 122, 123, 124, 125, 104 and 105. The sheet p is then reversed by the carrying roller pairs 104 and 105 and the registration roller pair 106 in a switchback-like manner and is carried again to the printing position. In this case, the carrying guides 130 and 131 are turned in predetermined directions so that the sheet p is carried through a predetermined carrying path.

Since the solution is selectively applied to the sheet p and normalized in accordance with the images on the face side and the back side, the floating of the forward edge of the sheet p due to the curling of the sheet or the floating of the central part due to the cockling of the sheet, generated by the adherence of the ink to the face side of the sheet p in the first recording (face-side recording), is reduced. Moreover, the curling and cockling of the sheet due to the sucking force to the carrying belt 107 is corrected and predetermined spacing can be maintained between the ink-jet heads 115 and the sheet p.

As the inks of the individual colors are ejected from the ink-jet heads 115C, 115M, 115Y and 115Bk synchronously with the timing when the sheet p is carried from the registration roller pair 106, a color image is formed at a desired position on the back side of the sheet p.

The sheet p with the images formed on its face side and back side is carried again by the carrying roller pairs 112, 113 and 114 and is discharged to the paper discharge tray 117 by the paper discharge roller pair 126. At this time, the carrying guide 130 is turned in a predetermined direction so that the sheet p is carried through a predetermined carrying path. If the sheet is discharged face down in the double-side recording, the back side is the first page and the face side is the second page. If the sheet is discharged face up, the face side is the first page and the back side is the second page.

In order to transfer the solution to an appropriate place on the back side of the sheet p, the solution selectively applied to the face side of the carrying belt 107 by the solution supply head 401 or 402 is a water-soluble liquid with its viscosity, permeability and the like adjusted, or a water-soluble treatment solution which improves image quality and water resistance. The solution applied to the entire surface is set to approximately 0.05 to 0.4 g per A4 sheet including the water content of the ink used for the image formation.

According to the above embodiment, cockling and curling generated immediately after recording on the surface of a recording medium can be reduced to an extent that does not affect the recording. Moreover, cockling and curling can be reduced in a final recording product after natural drying. Therefore, double-side print images of high print quality as well as single-side print images can be acquired.

The functions described in the above embodiment may be configured using hardware or may be realized by causing a computer to read a program describing the function using software. The functions may also be configured by properly selecting either software or hardware.

Moreover, the functions can also be realized by causing a computer to read a program stored in a recording medium, not shown. Here, the recording used in the embodiment can be of any recording format as long as the recording medium can record a program and can be read by a computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ink-jet image forming apparatus comprising:
an ink-jet head ejecting an aqueous ink to form an image on a surface of a recording medium;
a carrying belt carrying the recording medium and at least a part of which is situated upstream from the ink-jet head in a direction of carrying the recording medium; and
a solution adhering unit adhering a solution to a water-retentive surface of the carrying belt.

2. The ink-jet image forming apparatus of claim 1, wherein the solution is water, or a treatment solution with a wetting agent and a surface active agent.

3. The ink-jet image forming apparatus of claim 2, further comprising a controller making the solution adhere to a desired area on the recording medium.

4. The ink-jet image forming apparatus of claim 3, further comprising a recording medium reversing unit, after an image is formed on one side of the recording medium, reversing the face and back sides of the recording medium in order to form an image on the other side of the recording medium,
wherein the controller in a double-side printing mode controls operation of a recording medium carrying unit and the solution adhering unit and thus selectively humidifies a part of the recording medium.

5. The ink-jet image forming apparatus of claim 3, wherein the controller operates the solution adhering unit if one of the conditions is met:
(1) the environment of use of the machine has a predetermined humidity or lower;
(2) the size of the recording medium in a direction orthogonal to a direction in which the recording medium travels is a predetermined value or greater;
(3) the printing rate within a predetermined range from a forward edge of the recording medium is a predetermined value or greater;
(4) printing is executed in a double-side printing mode; and
(5) the basis weight of the recording medium is a predetermined value or smaller.

6. The ink-jet image forming apparatus of claim 3, further comprising a mechanism collecting a remaining part of the solution adhering to the carrying belt, or a mechanism reusing the remaining part of the solution.

7. The ink-jet image forming apparatus of claim 3, wherein the controller analyzes image position information and image information.

8. The ink-jet image forming apparatus of claim 7, wherein the controller temporarily stores the image position information and image density information as recording data, and also calculates position information and solution application information for an area where no image is formed on the basis of the image position information and the image density information and temporarily stores the calculated information as solution application unit information data.

9. The ink-jet image forming apparatus of claim 8, wherein the controller executes operation if a double-side printing instruction is given.

10. The ink-jet image forming apparatus of claim 9, wherein the controller causes the solution to adhere to an area where a total value of density of recorded images on the face side and back side of the recording medium is a predetermined value or smaller.

11. The ink-jet image forming apparatus of claim 2, wherein the solution adhering unit has the same structure as a head structure used in the ink-jet head.

12. The ink-jet image forming apparatus of claim 11, wherein the solution adhering unit ejects the solution in a direction of gravity.

13. The ink-jet image forming apparatus of claim 11, wherein the solution adhering unit ejects the solution in a direction opposite to a direction of gravity.

14. The ink-jet image forming apparatus of claim 2, further comprising:
a housing being provided in a manner that its top plate with plural holes or grooved provided thereon contacts a back side of the carrying belt; and
a fan sucking air from inside the housing; and
a controller operating the fan at least while the recording medium is carried on the carrying belt, wherein the carrying belt provides many through-holes.

15. An image forming method for an ink-jet image forming apparatus including an ink-jet head which ejects an aqueous ink to form an image on a surface of a recording medium, a carrying belt which carries the recording medium, and a solution adhering unit which adheres a solution to a surface of the carrying belt, the method comprising:
analyzing image position information and image information;
by a controller, temporarily storing the image position information and image density information as recording data, and also calculating position information and solution application information for an area where no image is formed on the basis of the image position information and the image density information and temporarily stores the calculated information as solution application unit information data;
causing the solution application unit to adhere the solution to the surface of the carrying belt on the basis of the solution application unit information data; and
ejecting the aqueous ink from the ink-jet head to form an image on the surface of the recording medium on the basis of the image information.

16. The image forming method of claim 15, wherein the solution is water, or a treatment solution with at least a wetting agent to improve wettability and a surface active agent.

17. The image forming method of claim 16, wherein operation is executed if a double-side printing instruction is given.

18. The image forming method of claim 16, wherein the solution is selectively ejected to the surface of the carrying belt.

19. The image forming method of claim 16, wherein density information of a recorded image is acquired, and
the solution is adhered to an area where the density of the recorded image on the recording medium is a predetermined value or smaller.
